(19) United States
(12) Patent Application Publication
(10) Pub. No.: US 2025/0027524 A1
(43) Pub. Date: Jan. 23, 2025

(54) MACHINING FIXTURE COUNTERBORE BOLT FITTING

(71) Applicant: Textron Innovations Inc., Providence, RI (US)

(72) Inventor: Timothy John Leibold, Andover, KS (US)

(73) Assignee: Textron Innovations Inc., Providence, RI (US)

(21) Appl. No.: 18/355,807

(22) Filed: Jul. 20, 2023

(51) Int. Cl. F16B 35/04; F16B 5/02

(52) U.S. Cl. CPC F16B 35/041; F16B 5/0275

(57) ABSTRACT

A machining fixture counterbore bolt fitting includes a counterbore bolt, (SHCS) screw and jam nut. The counterbore bolt defines an axial bore therethrough, sized to location clearance or sliding fit receive the screw and a counterbore sized to running fit receive a head of the screw and of a depth for the head of the screw to bear on the bottom of the counterbore. The counterbore bolt is threaded through a machining fixture to bring a distal end of the bolt into contact with a surface of a part to be machined, with the axial bore around a screw-threaded bore in a fixture mating surface of the part. The screw is threaded into the screw-threaded bore, holding the part against movement with respect to the fixture. The head of the screw bears on the counterbore bottom, pulling the fixture mating surface against the bolt shaft threaded through the machining fixture.

### TECHNICAL FIELD

The present disclosure relates generally to machining, more particularly to securing parts for machining, and specifically to a counterbore hex head bolt fitting for securing parts, such as aircraft forgings or castings, for machining.

### BACKGROUND

Cast or forged parts are often received for machining with machining fixture mating surfaces that do not match a three-dimensional (3-D) model of the part sufficiently that Computer Numerically Controlled (CNC)) machining of part can proceed. Typical solutions for positioning such a part for machining typically involves the use of complex clamps and/or bump pins, or an internally and externally threaded fitting. Such a threaded fitting would be threaded into a machining fixture using the external threads of the threaded fitting and a screw would be threaded through the internal threads of the threaded fitting, into contact with a part's mating surface of such a part to be machined, to adjust the part of the tool into a desired position. Another way to adjust a position of such a part to be machined, is to use shims and clamps, such as by shimming the part of the tool to the casting or forging in the desired position and then clamp the part in place, without the part moving.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present invention is directed to systems and methods which provide a machining fixture counterbore bolt fitting that includes a machining fixture counterbore bolt, screw (socket head cap screw (SHCS)) and jam nut.

The machining fixture counterbore bolt defines (hex) bolt head, a bolt shaft integral with the bolt head, extending from the bolt head, a smooth axial bore through the bolt head and bolt shaft, sized to location clearance or sliding fit receive a shaft of the screw and a smooth counterbore, coaxial with the axial bore through a portion of the bolt head, sized to running fit receive a head of the screw and of a depth for the head of the screw to bear on a remaining portion of the bolt head, inside the counterbore. Bolt threads defined on a surface of at least a distal portion of the bolt shaft are configured to be threaded through a machining fixture to bring a distal end of the bolt shaft into contact with a surface of a part to be machined, with a distal end of the axial bore around a screw-threaded bore in a fixture mating surface of the part to be machined. This screw-threaded bore in a fixture mating surface of the part to be machined may be a threaded insert disposed in a bore into the fixture mating surface of the part to be machined.

The screw has a screw shaft sized for location clearance or sliding fit rotation in the axial bore, with screw threads defined on a surface of at least a portion of the screw shaft and configured to be threaded into the screw-threaded bore in the fixture mating surface of the part to be machined, holding the part to be machined against movement with respect to the fixture. The head of the screw is sized to bear on a bottom of the counterbore in the bolt head, when the screw is tightened into the screw-threaded bore in the fixture mating surface, pulling the fixture mating surface into contact with the bolt shaft threaded through the machining fixture. Thus, the screw may have a length to enable it to bear the head of the screw on the bottom of the counterbore when threaded into the screw-threaded bore in the fixture mating surface of the part to be machined.

The jam nut is configured for threading onto the bolt threads into contact with an outer surface of the fixture.

In operation, the machining fixture counterbore bolt is threaded into the machining fixture into contact with the mating surface of the part to be machined. The jam nut may then be tightened on the bolt threads against the machining fixture, locking a position of the machining fixture counterbore bolt to the mating surface of the part to be machined. The screw may then be threaded into the screw-threaded bore in the fixture mating surface of the part to be machined, with the head of the screw bearing on the bottom of the counterbore, holding the part to be machined to match a three-dimensional engineer model.

Thereafter, the fixture may be adjusted to the part to be machined to further match the three-dimensional engineer model by loosening the jam nut from against the machining fixture, thereby, unlocking the position of the machining fixture counterbore bolt to the mating surface of the part to be machined. The machining fixture counterbore bolt may then be threaded part way out of the machining fixture, with the head of the screw bearing on the bottom of the counterbore, thereby, moving the machining fixture to the part to be machined. Then, the jam nut may be retightened on the bolt threads, against the machining fixture, thereby, locking a resulting position of the machining fixture counterbore bolt to the mating surface of the part to be machined, holding the part to be machined to further match the three-dimensional engineer model.

Alternatively, or additionally, the fixture may be adjusted to the part to be machined to further match the three-dimensional engineer model by loosening the jam nut from against the machining fixture, thereby, unlocking the position of the machining fixture counterbore bolt to the mating surface of the part to be machined. The machining fixture counterbore bolt may be threaded further into the machining fixture, moving the machining fixture to the part to be machined. then, the jam nut may be retightened on the bolt threads against the machining fixture, thereby, locking a resulting position of the machining fixture counterbore bolt to the mating surface of the part to be machined, holding the part to be machined to further match the three- dimensional engineer model.

Alternatively, or additionally, the fixture may be adjusted to the part to be machined to further match the three-dimensional engineer model by unlocking the position of the machining fixture counterbore bolt to the mating surface of the part to be machined by unthreading the screw out of the screw-threaded bore in the fixture mating surface of the part to be machined and removing the screw from the machining fixture counterbore bolt. Then, the jam nut may be loosed on the bolt threads from against the machining fixture and the machining fixture counterbore bolt may then be threaded out of the machining fixture. The fixture may then be moved away from the part to be machined by threading a longer machining fixture counterbore bolt further into the machining fixture into contact with the mating surface of the part to be machined. Then, a resulting position of the longer machining fixture counterbore bolt may be locked to the mating surface of the part to be machined by tightening the jam nut on the bolt threads of the longer machining fixture counterbore bolt, against the machining fixture. The part to be machined is then held to further match the three-dimensional engineer model by threading a longer screw into the screw-threaded bore in the fixture mating surface of the part to be machined.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Having thus described the invention in general terms, reference will now be made to the accompanying drawings, which are not necessarily drawn to scale, and which are incorporated in and form part of the specification and in which like numerals designate like parts, illustrate embodiments of the present invention and together with the description, serve to explain the principles of the invention. In the drawings:

FIG. 1 is an environmental perspective view showing use of two of the present machining fixture counterbore bolt fittings, according to some embodiments;

FIG. 2 is another environmental perspective view showing use of two of the present machining fixture counterbore bolt fittings, according to some embodiments;

FIG. 3 is a generally cross-sectional fragmented view of use of the present machining fixture counterbore bolt fitting, according to some embodiments;

FIG. 4 is another environmental perspective view, without the part to be machined, showing use of two of the present machining fixture counterbore bolt fitting, according to some embodiments;

FIG. 5 is an enlarged environmental perspective view, without the part to be machined, showing use of the present machining fixture counterbore bolt fitting, according to some embodiments; and

FIG. 6 is another enlarged environmental perspective view showing use of the present machining fixture counterbore bolt fitting, according to some embodiments.

While this specification provides several embodiments and illustrative drawings, a person of ordinary skill in the art will recognize that the present specification is not limited only to the embodiments or drawings described. It should be understood that the drawings and detailed description are not intended to limit the specification to the particular form disclosed, but, on the contrary, the intention is to cover all modifications, equivalents and alternatives falling within the spirit and scope of the claims. Also, any headings used herein are for organizational purposes only and are not intended to limit the scope of the description. As used herein, the word “may” is meant to convey a permissive sense (i.e., meaning “having the potential to”), rather than a mandatory sense (i.e., meaning “must”). Similarly, the words “include,” “including,” and “includes” mean “including, but not limited to.”

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention. For example, although embodiments of the present systems and methods may be described below with reference to machining a tiltrotor aircraft component, embodiments of the present systems and methods may be applicable to machining various types of parts, and the like. Embodiments of the present machining fixture counterbore bolt fitting may be used anytime an individual needs to position and locate material to be machined. In the illustrated application(s) of embodiments of the present machining fixture counterbore bolt fitting, a casting is shown as being positioned using the illustrated embodiment(s) of the present machining fixture counterbore bolt fitting.

Embodiments described herein relate generally to machining, more particularly to securing parts for machining, and specifically to a counterbore hex head bolt fitting for securing parts, such as aircraft castings or forgings, for machining.

As described in greater detail below, embodiments of the present machining fixture counterbore bolt fitting may be a counterbore bolt fitting, embodied in a hex head bolt with an axial bore through it and a co-axial counterbore into its head, or the like. Specifically, embodiments the machining fixture counterbore bolt may have an external thread size and pitch of ¾ inch and 10 threads per inch, respectively, with a counterbore for a ⅜ inch, 16 threads per inch, socket head cap screw (SHCS), fillister head screw, or the like, generally referred to herein as a “screw,” “SHCS,” or the like. Embodiments of the present machining fixture counterbore bolt fitting enable easy adjustment of a cast or forged mating surface to be machined that does not match a three-dimensional model. In accordance with various embodiments, this adjustment is accomplished by threading the present machining fixture counterbore bolt into a fixture arm, or the like, until the tip of the machining fixture counterbore bolt is touching a mating surface of the casting or forged part. Then, once the end of the machining fixture counterbore bolt is touching this surface, a jam nut on the machining fixture counterbore bolt is tightened against the fixture arm to lock the position of the machining fixture counterbore bolt to the mating surface. Next, the SHCS is passed through the counterbore and threaded into the part's mating surface, such as into a threaded insert disposed into the part's mating surface. The 3/8-16 SHCS holds the part, such as with the head of the SHCS within the counterbore and secured from (out of the way of) contact by a machining head, or the like.

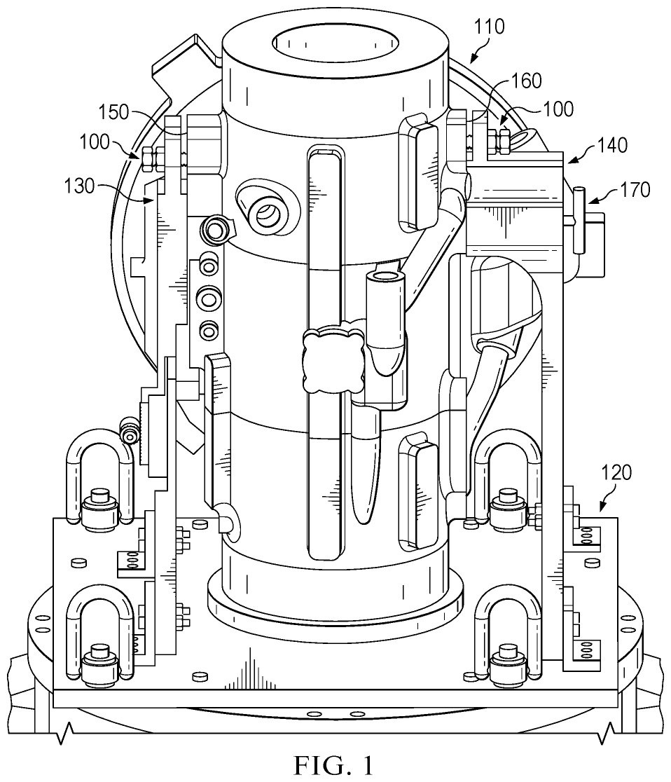

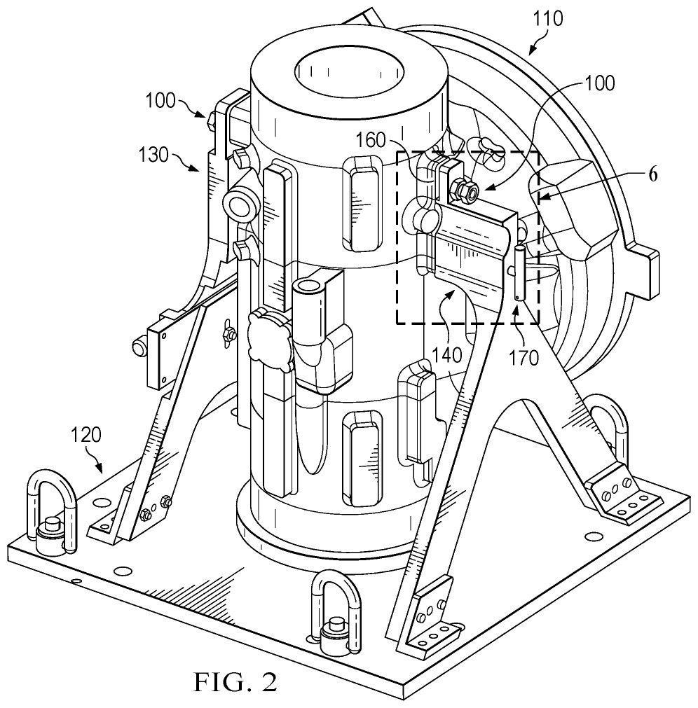

FIG. 1 is an environmental perspective view, and FIG. 2 is another environmental perspective view (from another angle), both showing use of two of present machining fixture counterbore bolt fittings 100, according to some embodiments. In the example of FIGS. 1 and 2, a part to be machined, casting or forged part 110, is shown on a part bearing surface which consists of a slotted boss to roughly position part 110, holding fixture plate assembly 120.

Fixtures, fixture arms 130 and 140, secured to holding fixture plate assembly 120, extend upward to maintain a gap between a fixture mating surfaces 150 and 160, respectively, of part to be machined 110. Various attachment points of fixture arms 150 and 160 may be slotted for greater flexibility in positioning the fixture arms. Holding fixture plate assembly 120 may, in turn be mounted on a machine turntable that may rotate 360 degrees in a flat plane. The associated head of a milling machine (e.g., a horizontal four-axis milling machine, or the like) may machine part 110 in a horizontal or vertical position. However, problematically, cast or forged mating surfaces 150 and 160 may not be planar. For example, one, or both, of surfaces 150 and 160 may be concave of convex.

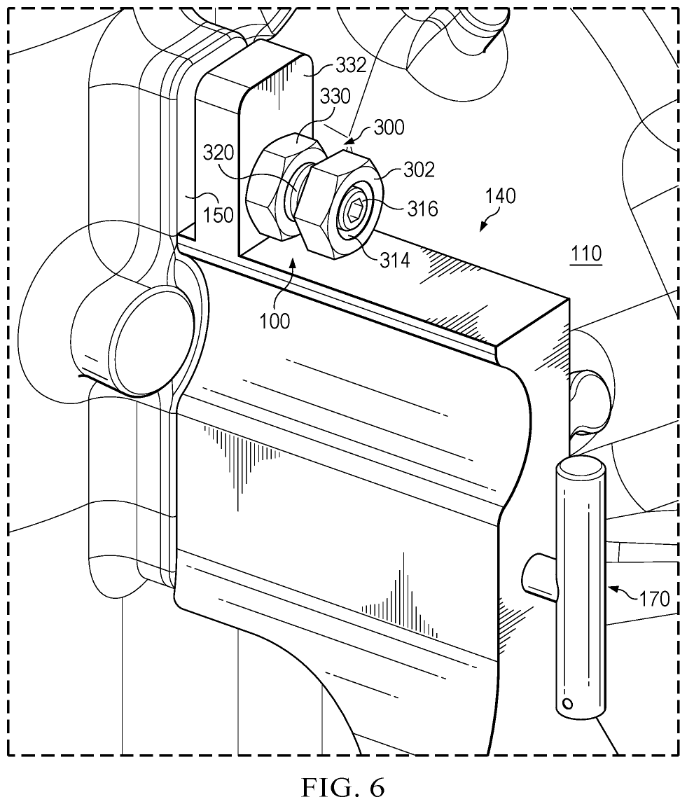

In accordance with various embodiments, machining fixture counterbore bolt fittings 100 are fitted, in FIGS. 1 and 2, to distal ends of fixture arms 130 and 140 to engage with, and enable adjustment of, cast or forged mating surfaces 150 and 160, respectively, to facilitate Computer Numerically Controlled (CNC)) machining of part 110, or the like, according to a three-dimensional model. Illustrated part to be machined 110 in FIGS. 1 and 2 (and FIG. 6, below) is an aircraft component, in this particular case a tiltrotor primary gearbox housing, specifically a tiltrotor Prop Rotor Gear Box (PRGB).

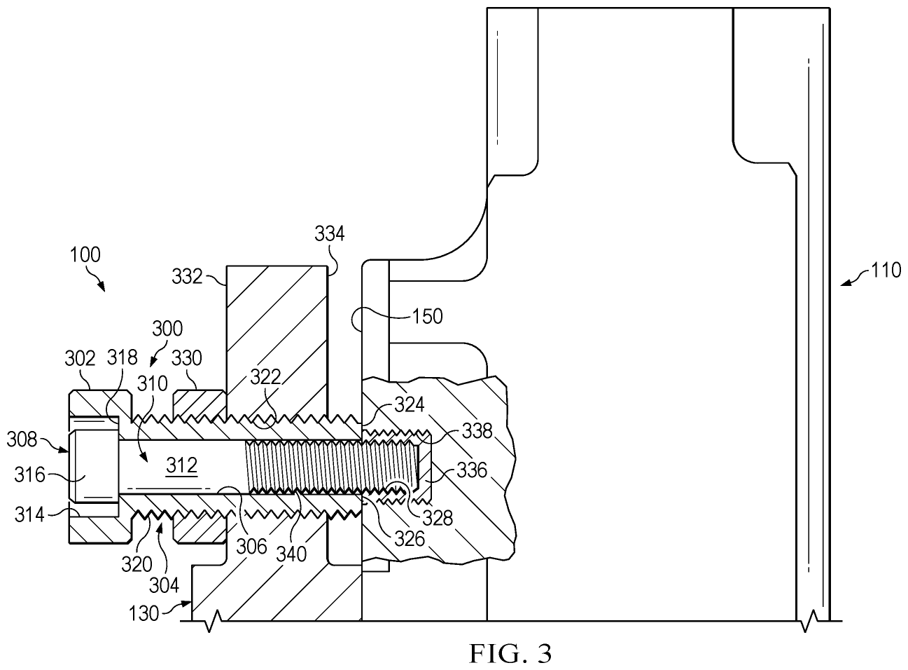

FIG. 3 is a generally cross-sectional fragmented view of present machining fixture counterbore bolt fitting 100, and use of present machining fixture counterbore bolt fitting 100, according to some embodiments. Therein, integral machining fixture counterbore bolt 300, having bolt head 302 and bolt threaded shaft 304, integral with the bolt head and extending from the bolt head, is shown. Bolt 300 may be a hex (hexagonal) head bolt, as illustrated or may be of any number of other bolt configurations.

Smooth axial bore 306 is defined through bolt 300, that is, through bolt head 302 and bolt threaded shaft 304, integral to bolt 300. Smooth axial bore 306 is sized (has a diameter) to location clearance (LC1 to LC11) to sliding (RC1 or RC2) fit receive screw 308, in particular shaft 310, specifically, (unthreaded) shank 312 of screw shaft 310, in the illustrated embodiment. As noted, screw 308 may be a SHCS, or the like.

Smooth counterbore 314 is defined, coaxial with the axial bore, through a portion of bolt head 302, to receive head 316 of screw 308. Smooth counterbore 314 is sized (has a diameter) to running fit receive head 316 of screw 308, and the counterbore 314 is of a depth, and is sized, such that head 316 of screw 308 can bear on bottom 318 of counterbore 314, in the counterbore.

Bolt threads 320 are defined on a surface of at least a distal portion of bolt shaft 304. These threads are, configured, that is sized and pitched (having a diameter and thread pitch) to be threaded through a threaded bore 322 defined in machining fixture 130. These threads may, in accordance with various embodiments, be threaded through machining fixture 130 to bring a distal end 324 of bolt shaft 304 into contact with surface 150 of part to be machined 110, with distal end 326 of axial bore 306 around threaded bore 328 in fixture mating surface 150 of part to be machined 110. Jam nut 330 is configured for threading onto bolt threads 320 into contact with (outer) surface 332 of fixture 130 to lock the position of machining fixture counterbore bolt 300 to mating surface 150. Alternatively (or additionally) the jam nut (or another, additional jam nut) may be threaded onto bolt threads 320 into contact with an inner surface 334 of fixture 130 to lock the position of machining fixture counterbore bolt 300 to mating surface 150.

Threaded bore 328 in fixture mating surface 150 of part to be machined 110 may be provided by threaded insert 336 disposed in bore 338 into fixture mating surface 150 of part to be machined 110. Further, bolt shaft 304 may include a (unthreaded) bolt shank portion (not shown) between bolt head portion 302 and bolt threads 320.

In accordance with the forgoing, screw shaft 310, particularly (unthreaded) shank 312 is sized (has a diameter) for location clearance (LC1 to LC11) to sliding (RC1 or RC2) fit, including rotation, in bore 306. Screw threads 340 defined on a surface of at least a portion of screw shaft 310 are configured to (i.e., sized and pitched) be threaded into threaded bore 328 in the fixture mating surface 150 of part to be machined 110, holding part to be machined 110 against movement with respect to fixture 130. Head 316 of screw 308 is sized (e.g., of a diameter larger than axial bore 306, but smaller than counterbore 314 to bear on bottom 318 of counterbore 314 in bolt head 302, when screw 308 is tightened into threaded bore 328 in fixture mating surface 150, pulling fixture mating surface 150, and thus part to be machined 110, into (rigid) contact with bolt shaft 304 (distal end 324) threaded through machining fixture 130. Thusly, the head of the SHCS is disposed within the counterbore and secured from (out of the way of) contact by a machining head, or the like. In accordance therewith, screw 308 has a length to bear head 316 of the screw on bottom 318 of counterbore 314, while sufficient to be threaded into threaded bore 328 in fixture mating surface 150 of part to be machined 110, and the counterbore has sufficient depth to receive the head of the SHCS.

Thus, in operation, embodiments of the present machining fixture counterbore bolt fitting 100 may be fitted to fixtures, such as fixture arms (130 and 140) to engage with, and enable positioning of, cast or forged mating surfaces (150 and 160, respectively), to facilitate CNC machining of part 110, or the like, according to a three-dimensional model, as follows, with reference to FIGS. 1 and 2, and particularly 3, by way of example.

A part to be machined (110) is placed on a holding fixture plate assembly (120), or the like and held in position, such as through use of one or more T-pins 170. The part (110) may then be probed to determine proper positioning for machining. A machining fixture counterbore bolt (300) is threaded into a machining fixture (e.g., arm 130) into contact (until it stops) with a mating surface (150) of a part to be machined (110). The part (110) may then be probed to determine proper positioning for machining and the depth the bolt is screwed into the fixture arm may be adjusted until the probing indicates the part is in the proper position. bolt may. The resulting position of the machining fixture counterbore bolt (300) may then be “locked” to the mating surface (150) of the part to be machined (110) by tightening a jam nut (330) on the machining fixture counterbore bolt threads (320) against (a surface (332) of) the machining fixture (130). Then a (SHCS) screw (308) is inserted through the bolt axial bore (306 and threaded into a threaded bore (328) in the fixture mating surface (150) of the part to be machined (110), with a head (316) of the screw (308) bearing on a bottom (318) of the counterbore (314), holding the part to be machined (110) to match the aforementioned three-dimensional engineer model. In accordance with the foregoing the part may be first secure, and/or positioned using a first of the fixture arms, and then secured and/or positioned using a second fixture arm, etc. The part (110) may be probed to confirm proper positioning for machining. Additionally, or alternatively, if there is no threaded bore (328) in the machining fixture (150), or an existing threaded bore in the machining fixture is not in position to be used in accordance wherewith for treading the SHCS (308) into it, the axial bore (306) may be used as a guide to drill and tap a threaded bore into, to the machining fixture.

The position of the part to be machined (110) can be further adjusted, such as to more closely match the three-dimensional engineer model, by unlocking the position of the machining fixture counterbore bolt (300) to the mating surface (150) of the part to be machined (110) by loosening the jam nut (330) from against the machining fixture (130), then the machining fixture may be moved to the part to be machined (110) by threading the machining fixture counterbore bolt (300) part way out of the machining fixture, with the head (316) of the screw (308) bearing on the bottom (318) of the counterbore (314) pushing the part (110), and thereby moving the machining fixture to the part to be machined. The part (110) may then be probed to confirm proper positioning for machining. Alternatively, the machining fixture (arm) (130) may be moved to the part to be machined (110) by threading the machining fixture counterbore bolt (300) deeper (i.e., further) into the machining fixture (arm) (130), toward the part to be machined (110). In either case, the part to be machined (110) may then be held to further match the three- dimensional engineer model by locking the resulting position of the machining fixture counterbore bolt (300) to the mating surface (150) of the part to be machined (110) by retightening the jam nut (330) on the bolt threads (320), against the machining fixture (arm) (130) (surface (332)). The part (110) may then be probed to confirm proper positioning for machining.

In various embodiments, the position of the machining fixture (arms) to the part to be machined may be still further adjusted to still further match the three-dimensional engineer model. For example, the position of the machining fixture counterbore bolt (300) to the mating surface (150) of the part to be machined (110) may be unlocked by unthreading the screw (308) out of the threaded bore (328) in the fixture mating surface (150) of the part to be machined (110) and removing the screw from the machining fixture counterbore bolt (300). Then the jam nut (330) on the bolt threads (320) is loosened from against the machining fixture (arm) (130) (surface (332)) and unthreading the machining fixture counterbore bolt (300) out of the machining fixture (arm) (130). After thus unlocking the machining fixture counterbore bolt (300) from the mating surface (150) of the part to be machined (110), the fixture (arm) (130) may be moved away from the part to be machined by threading a longer machining fixture counterbore bolt (i.e., a machining fixture counterbore bolt (300) having longer threads section (320)) further into the machining fixture (arm) (130) into contact with the mating surface (150) of the part to be machined (110) the part to be machined. Then, the resulting position of the longer machining fixture counterbore bolt with respect to the mating surface (150) of the part to be machined (110) is locked by tightening a jam nut on bolt threads of the longer machining fixture counterbore bolt against the machining fixture (arm) (130) (surface (332)). The part to be machined (110) can then be held to further match the three-dimensional engineer model by threading a (n) (overall) longer screw (SHCS) into the threaded bore (328) in the fixture mating surface (150) of the part to be machined (110). The part (110) may then be probed to confirm proper positioning for machining. In accordance therewith, when a longer bolt and screw are used, their respective lengths should be maintained, such that the screw can thread into the threaded bore in the fixture mating surface machining and still bear on the bottom of the counterbore.

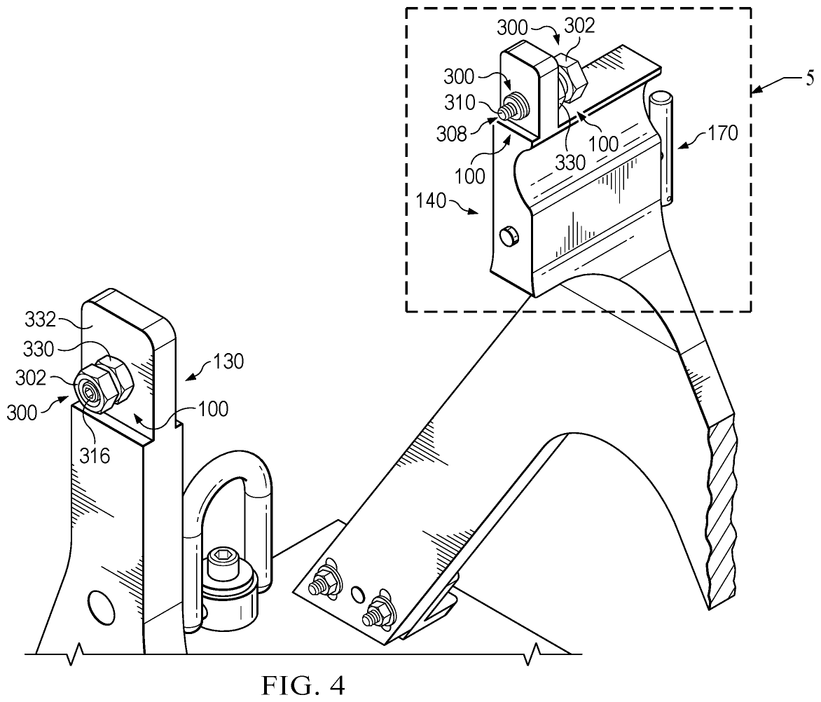

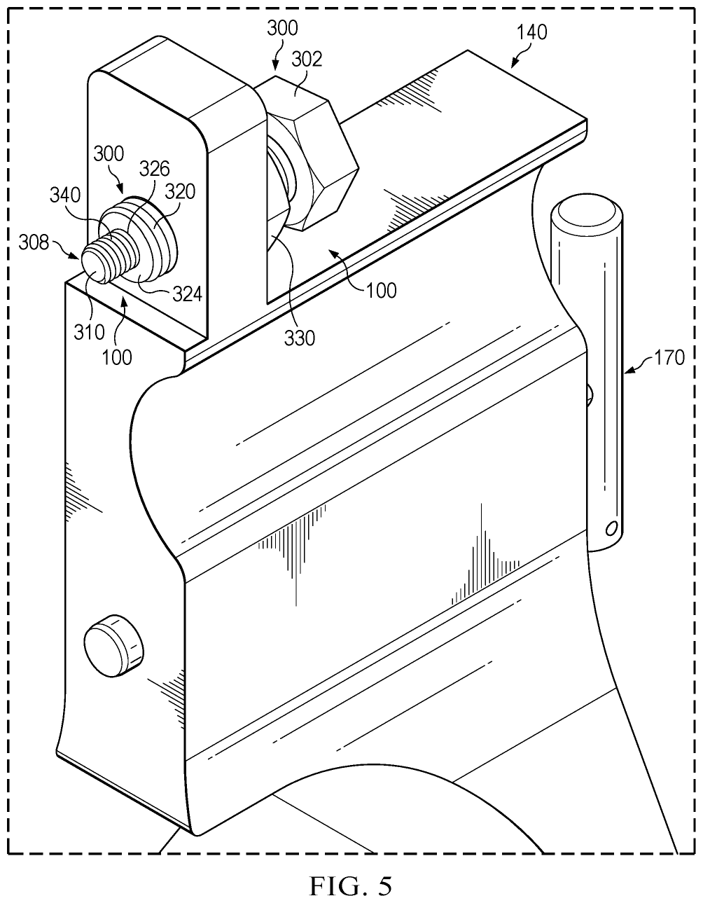

FIG. 4 is another environmental perspective view, without part to be machined 110, for purposes of illustration, to show use of two of present machining fixture counterbore bolt fittings 100, according to some embodiments. FIG. 5 is an enlarged environmental perspective view of a portion of FIG. 4, without part to be machined 110, showing use of one of the present machining fixture counterbore bolt fittings 100, according to some embodiments. FIG. 6 is another enlarged environmental perspective view showing use of one of present machining fixture counterbore bolt fittings 100, according to some embodiments. In FIGS. 4 through 6, and with reference back to FIG. 3, machining fixture counterbore bolt fitting 100, including machining fixture counterbore bolt 300′s head 302, threaded (320) and bolt shaft 304, is seen, as is jam nut 330 threaded onto bolt threads 320, into contact with surface 332 of fixture(s) (arm(s)) 130 and 140. Head 316 of screw (SHCS) 308 is shown in counterbore 314, such as to bear on bottom 318 inside the counterbore. Distal end 324 of bolt shaft 304 is show in potion to contact surface 150 of part to be machined 110, such as with distal end 326 of axial bore 306 around threaded bore 328 in fixture mating surface 150 of part to be machined 110. Also, a distal end of screw 308 is shown with threaded screw shaft 310 extending from distal end 324 of bolt 300, are shown, but as noted above, and shown in FIG. 3, would be threaded into threaded bore 328 in the fixture mating surface 150 or 160 of part to be machined 110, holding part to be machined 110 against movement with respect to fixture (arm) 130 or 140.

In accordance with the foregoing, embodiments of the present machining fixture counterbore bolt fitting provides a straightforward, very flexible solution for adjusting a part to be machined, for machining, avoiding use of shims, or the like. Further, in contrast to an internally and externally threaded fitting, or the like, embodiments of the present machining fixture counterbore bolt initially contact a part to be machined and can be locked into position (locking the part to be machined in position) using (a) jam nut(s), or the like, to hold the part to be machined in place. Then a SHCS, or the like, is freely passed through the counterbore bolt, to be tighten into a threaded bore in a fixture mating surface of the part, and bear on a bottom of the bolt counterbore, to secure and hold the part for machining. Thus, in contrast with using a fitting that consists of threads in the fitting, which gives very little flexibility if the insert in the part does not line up with the bolt that would be threaded in the that fitting, the present machining fixture counterbore bolt fitting (100) employs a location clearance or sliding fit between the axial bore (306) through the bolt head (302) and bolt shaft (304). That is the machining fixture counterbore bolt (300) has an axial bore (306) larger than the screw's shaft (310). For example, using a 3/8-16 SHCS in which the shank diameter is 0.375 inch, the present machining fixture counterbore bolt fitting (100) has a 0.397 inch diameter axial bore. This gives us a 0.011 inch “play” or “slop” due to a diametral gap of 0.022 inch, for engagement of the screw threads (340) in the threaded bore (332) in the part's fixture mating surface (150).

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A machining fixture counterbore bolt comprising:
a bolt head;
a bolt shaft integral with the bolt head, extending from the bolt head;
a smooth axial bore through the bolt head and bolt shaft, sized to location clearance or sliding fit receive a shaft of a screw;
a smooth counterbore, coaxial with the axial bore, through a portion of the bolt head, sized to running fit receive a head of the screw, the counterbore of a depth and the axial bore sized, for the head of the screw to bear on a bottom of the counterbore, in a remaining portion of the bolt head, in the counterbore; and
bolt threads defined on a surface of at least a distal portion of the bolt shaft, configured to be threaded through a machining fixture to bring a distal end of the bolt shaft into contact with a surface of a part to be machined, with a distal end of the axial bore around a screw-threaded bore in a fixture mating surface of the part to be machined.

2. The machining fixture counterbore bolt of claim 1, wherein the smooth axial bore through the bolt head and bolt shaft is sized to location clearance or sliding fit receive a shank portion of a shaft of the screw.

3. The machining fixture counterbore bolt of claim 1, wherein the bolt head is a hex bolt head.

4. The machining fixture counterbore bolt of claim 1, wherein the bolt threads are configured to be threaded through the machining fixture by being sized and pitched to be threaded through a bolt-threaded bore defined in the machining fixture.

5. The machining fixture counterbore bolt of claim 1, wherein the bolt shaft portion further comprises a bolt shank portion between the bolt head portion and the bolt threads.

6. A machining fixture counterbore bolt fitting comprising:
a machining fixture counterbore bolt defining:
a bolt head;
a bolt shaft integral with the bolt head, extending from the bolt head;
a smooth axial bore through the bolt head and bolt shaft, sized to location clearance or sliding fit receive a shaft of a screw;
a smooth counterbore, coaxial with the axial bore through a portion of the bolt head, sized to running fit receive a head of the screw and of a depth for the head of the screw to bear on a remaining portion of the bolt head, inside the counterbore; and
bolt threads defined on a surface of at least a distal portion of the bolt shaft, configured to be threaded through a machining fixture to bring a distal end of the bolt shaft into contact with a surface of a part to be machined, with a distal end of the axial bore around a screw-threaded bore in a fixture mating surface of the part to be machined; the screw comprising:
a screw shaft sized for location clearance or sliding fit rotation in the axial bore;
screw threads defined on a surface of at least a portion of the screw shaft, configured to be threaded into the screw-threaded bore in the fixture mating surface of the part to be machined, holding the part to be machined against movement with respect to the fixture; and
the head of the screw sized to bear on a bottom of the counterbore in the bolt head, when the screw is tightened into the screw-threaded bore in the fixture mating surface, pulling the fixture mating surface into contact with the bolt shaft threaded through the machining fixture; and
a jam nut configured for threading onto the bolt threads into contact with an outer surface of the fixture.

7. The machining fixture counterbore bolt fitting of claim 6, wherein the bolt head is a hex bolt head.

8. The machining fixture counterbore bolt fitting of claim 6, wherein the bolt threads are configured to be threaded through the machining fixture by being sized and pitched to be threaded through a bolt-threaded bore defined in the machining fixture.

9. The machining fixture counterbore bolt fitting of claim 6, wherein the bolt shaft portion further comprises a bolt shank portion between the bolt head portion and the bolt threads.

10. The machining fixture counterbore bolt fitting of claim 6, wherein the screw has a length to bear the head of the screw on the bottom of the counterbore when threaded into the screw- threaded bore in the fixture mating surface of the part to be machined.

11. The machining fixture counterbore bolt fitting of claim 6, wherein the screw is a socket head cap screw (SHCS).

12. The machining fixture counterbore bolt fitting of claim 6, wherein:
the screw shaft portion further comprises a screw shank portion, between the screw head portion and the screw threads; and
the smooth axial bore through the bolt head and bolt shaft is sized to location clearance or sliding fit receive the screw shank portion of the shaft of the screw.

13. The machining fixture counterbore bolt fitting of claim 6, wherein the screw threads are configured to be threaded into the screw-threaded bore in the fixture mating surface of the part to be machined by being sized and pitched to be threaded into the screw-threaded bore in the fixture mating surface of the part to be machined.

14. The machining fixture counterbore bolt fitting of claim 6, wherein the screw-threaded bore in the fixture mating surface of the part to be machined comprises a threaded insert disposed in a bore into the fixture mating surface of the part to be machined.

15. The machining fixture counterbore bolt fitting of claim 6, wherein the machining fixture extends from a part bearing surface.

16. A method comprising:
threading a machining fixture counterbore bolt into a machining fixture into contact with a mating surface of a part to be machined, the machining fixture counterbore bolt defining:
a bolt head;
a bolt shaft integral with the bolt head, extending from the bolt head;
a smooth axial bore through the bolt head and bolt shaft, sized to location clearance or sliding fit receive a screw shaft;
a smooth counterbore, coaxial with the axial bore through a portion of the bolt head, sized to running fit receive a screw head, with the screw head bearing on a bottom of the counterbore; and
bolt threads defined on a surface of at least a distal portion of the bolt shaft, configured to be threaded through the machining fixture to bring a distal end of the bolt shaft into contact with a surface of the part to be machined, with a distal end of the axial bore around a screw-threaded bore in the fixture mating surface of the part to be machined;
tightening a jam nut on the bolt threads against the machining fixture, locking a position of the machining fixture counterbore bolt to the mating surface of the part to be machined;
threading a screw into the screw-threaded bore in the fixture mating surface of the part to be machined, with a head of the screw bearing on the bottom of the counterbore, holding the part to be machined to match a three-dimensional engineer model.

17. The method of claim 16, wherein the screw has a length to bear the head of the screw on the bottom of the counterbore when threaded into the screw-threaded bore in the fixture mating surface of the part to be machined.

18. The method of claim 16, further comprising adjusting the fixture to the part to be machined to further match the three-dimensional engineer model by:
loosening the jam nut from against the machining fixture, unlocking the position of the machining fixture counterbore bolt to the mating surface of the part to be machined;
threading the machining fixture counterbore bolt part way out of the machining fixture, with the head of the screw bearing on the bottom of the counterbore, moving the machining fixture to the part to be machined; and
retightening the jam nut on the bolt threads against the machining fixture, locking a resulting position of the machining fixture counterbore bolt to the mating surface of the part to be machined, holding the part to be machined to further match the three-dimensional engineer model.

19. The method of claim 16, further comprising adjusting the fixture to the part to be machined to further match the three-dimensional engineer model by:
loosening the jam nut from against the machining fixture, unlocking the position of the machining fixture counterbore bolt to the mating surface of the part to be machined;
threading the machining fixture counterbore bolt further into the machining fixture, moving the machining fixture to the part to be machined; and
retightening the jam nut on the bolt threads against the machining fixture, locking a resulting position of the machining fixture counterbore bolt to the mating surface of the part to be machined, holding the part to be machined to further match the three-dimensional engineer model.

20. The method of claim 16, further comprising adjusting the fixture to the part to be machined to further match the three-dimensional engineer model by:
unlocking the position of the machining fixture counterbore bolt to the mating surface of the part to be machined by:
unthreading the screw out of the screw-threaded bore in the fixture mating surface of the part to be machined;
removing the screw from the machining fixture counterbore bolt;
loosening the jam nut on the bolt threads from against the machining fixture; and
unthreading the machining fixture counterbore bolt out of the machining fixture;
moving a fixture away from the part to be machined by threading a longer machining fixture counterbore bolt further into the machining fixture into contact with the mating surface of the part to be machined;
locking a resulting position of the longer machining fixture counterbore bolt to the mating surface of the part to be machined by tightening the jam nut on bolt threads of the longer machining fixture counterbore bolt against the machining fixture; and
holding the part to be machined to further match the three-dimensional engineer model by threading a longer screw into the screw-threaded bore in the fixture mating surface of the part to be machined.
